(19) United States
(12) Patent Application Publication
(10) Pub. No.: US 2015/0177884 A1
(43) Pub. Date: Jun. 25, 2015

(54) APPARATUS FOR SENSING TOUCH INPUT IN ELECTRONIC DEVICE

(71) Applicant: Samsung Electronics Co., Ltd., Suwon-si (KR)

(72) Inventor: Dongkyoon HAN, Seongnam-si (KR)

(21) Appl. No.: 14/580,541

(22) Filed: Dec. 23, 2014

(30) Foreign Application Priority Data
Dec. 23, 2013 (KR) 10-2013-0161346

(51) Int. Cl. G06F 3/044; G06K 9/00

(52) U.S. Cl. CPC G06F 3/044; G06K 9/0002; G06F 2203/04112

(57) ABSTRACT

A touch screen apparatus having a fingerprint sensing function is provided. The touch screen apparatus includes a color filter layer including a first black matrix line, which is located between each of pixels or each of sub-pixels and is arranged in a first direction, and including a second black matrix line, which is arranged in a second direction that is perpendicular to the first direction. In addition, the touch screen apparatus includes a thin film transistor (TFT) layer including a gate line and a data line, and a sensor layer located between the color filter layer and the TFT layer, the sensor layer including a first electrode, which is spatially arranged with the first black matrix line, and including a second electrode, which is spatially arranged with the second black matrix line.

### CROSS-REFERENCE TO RELATED APPLICATION(S)

This application claims the benefit under 35 U.S.C. §119(a) of a Korean patent application filed on Dec. 23, 2013 in the Korean Intellectual Property Office and assigned Serial number 10-2013-0161346, the entire disclosure of which is hereby incorporated by reference.

### TECHNICAL FIELD

The present disclosure relates to an apparatus for sensing a touch input in an electronic device. More particularly, the present disclosure relates to an apparatus having a fingerprint sensing function for sensing a fingerprint.

### BACKGROUND

In general, a touch panel is a device which may be configured in combination with a display device such as an organic light-emitting diode (OLED), a liquid crystal display (LCD), or the like, and is capable of generating a finger or pen touch input of a user while the user is viewing a screen of the display device. Such a touch panel may be an optical type touch panel that uses infrared detection, a capacitance type touch panel that senses a change of capacitance after forming a transparent conductive film in which an indium tin oxide (ITO) film is coated on a polyester film, or a pressure type touch panel that senses a location through a distribution of power using a pressure sensor for detecting a pressure of a finger that touches the panel. The touch panel having the above mentioned configuration may sense a finger touch or a pen touch input.

The electronic device may perform various functions, and thus, may store security information of the user. Therefore, the electronic device may be operated by inputting a password or a pattern when the electronic device is to be used. In addition, a security feature may be enhanced by installing a fingerprint sensor in the touch panel. In the fingerprint sensor, an electrode should be in contact with a finger, or a module may be manufactured in the form of a flexible printed circuit board (FPCB) to be mounted outside the screen as, for example, a home key. If fingerprint sensing is to be performed in the touch panel, an ITO film having a high transmissivity should be used in order to not block a content of screen.

As described above, if the fingerprint sensor is to be configured in the touch panel, the ITO film having a high transmissivity should be used in order to not block the content of screen which is displayed on a display of the touch panel. However, a width of the electrode for fingerprint sensing is considerably less than a width of the electrode for a touch panel according to the related art, and should be less than an interval between a valley and a ridge of a fingerprint, and therefore, an electrode resistance is increased by several tens of times compared to the touch panel. Accordingly, there may be a problem of a resistor-capacitor (RC) delay, and a deterioration of touch sensitivity, or the like. In addition, when a sensor, which is able to perform fingerprint sensing using ITO, is to be disposed in the touch panel, it should be placed on a touch screen. Hence, a transmittance of screen is decreased, and, when an ITO fingerprint sensor and the touch screen overlap, there may be a problem in a sensing operation of the touch screen.

The above information is presented as background information only to assist with an understanding of the present disclosure. No determination has been made, and no assertion is made, as to whether any of the above might be applicable as prior art with regard to the present disclosure.

### SUMMARY

Aspects of the present disclosure are to address at least the above-mentioned problems and/or disadvantages and to provide at least the advantages described below. Accordingly, an aspect of the present disclosure is to provide a touch panel device that forms an electrode of a touch panel in the manner of depositing a metal wire in a black matrix line region between pixels of a display panel, thereby implementing a high-resolution touch sensor regardless of pixel density.

In accordance with an aspect of the present disclosure, a touch screen apparatus having a fingerprint sensing function is provided. The touch screen apparatus includes a color filter layer including a first black matrix line, which is located between each of pixels or each of sub-pixels and is arranged in a first direction, and including a second black matrix line, which is arranged in a second direction that is perpendicular to the first direction, a thin film transistor (TFT) layer including a gate line and a data line, and a sensor layer located between the color filter layer and the TFT layer, the sensor layer including a first electrode, which is spatially arranged with the first black matrix line, and including a second electrode, which is spatially arranged with the second black matrix line.

In accordance with another aspect of the present disclosure, a touch screen sensor apparatus is provided. The touch screen sensor apparatus includes a color filter array including first black matrix lines, which are arranged in a first direction between a plurality of pixels or a plurality of sub-pixels disposed in a display region, and including second black matrix lines, which are arranged in a second direction, the first direction being perpendicular to the second direction, and a sensor array including first electrodes disposed in a bottom of the color filter array and overlapping a first black matrix line of the first black matrix lines, including second electrodes disposed in a bottom of the color filter array and overlapping a second black matrix line of the second black matrix lines, and including a fingerprint sensing region, wherein the first electrodes are partially arranged in the fingerprint sensing region of the sensor array and include a first drive line and a second drive line, the first drive line operating as a drive line outside of the fingerprint sensing region, and wherein the second electrodes include a first sensing line and a second sensing line, the first sensing line operating as a sensing line outside of the fingerprint sensing region.

Other aspects, advantages, and salient features of the disclosure will become apparent to those skilled in the art from the following detailed description, which, taken in conjunction with the annexed drawings, discloses various embodiments of the present disclosure.

### BRIEF DESCRIPTION OF THE DRAWINGS

The above and other aspects, features, and advantages of certain embodiments of the present disclosure will be more apparent from the following description taken in conjunction with the accompanying drawings, in which:

FIG. 1 is a block diagram illustrating a configuration of an electronic device having a touch screen sensor according to an embodiment of the present disclosure;

FIG. 2 is a side view of an electrode structure of a touch screen sensor according to an embodiment of the present disclosure;

FIG. 3 is a diagram illustrating a structure of a color filter and a black matrix line of a screen sensor according to an embodiment of the present disclosure;

FIG. 4 is a diagram illustrating a structure of an electrode layer of a screen sensor according to an embodiment of the present disclosure;

FIGS. 5A, 5B, and 5C are diagrams illustrating a location of fingerprint sensing in a touch screen sensor according to various embodiments of the present disclosure;

FIG. 6 is a side view of an electrode of a touch sensor, illustrating an operation of performing fingerprint sensing in a touch screen sensor according to an embodiment of the present disclosure;

FIGS. 7A, 7B, and 7C are diagrams illustrating a configuration of an example of fixing and using a fingerprint sensing region in a touch screen sensor according to various embodiments of the present disclosure;

FIGS. 8A and 8B are diagrams enlarging and displaying a fingerprint sensing region in a screen according to various embodiments of the present disclosure;

FIGS. 9A, 9B, and 9C are diagrams illustrating an example of an arrangement of a first electrode and a second electrode in a fingerprint sensing region according to various embodiments of the present disclosure;

FIG. 10 is a diagram illustrating an operation of applying a drive signal to electrodes disposed in a fingerprint sensing region and sensing a driven signal according to an embodiment of the present disclosure; and

FIG. 11 is a diagram illustrating an example of sensor electrode routing when a touch sensor for fingerprint sensing is configured as a swipe type in a touch screen sensor according to an embodiment of the present disclosure.

Throughout the drawings, it should be noted that like reference numbers are used to depict the same or similar elements, features, and structures.

### DETAILED DESCRIPTION

The following description with reference to the accompanying drawings is provided to assist in a comprehensive understanding of various embodiments of the present disclosure as defined by the claims and their equivalents. It includes various specific details to assist in that understanding but these are to be regarded as merely exemplary. Accordingly, those of ordinary skill in the art will recognize that various changes and modifications of the various embodiments described herein can be made without departing from the scope and spirit of the present disclosure. In addition, descriptions of well-known functions and constructions may be omitted for clarity and conciseness.

The terms and words used in the following description and claims are not limited to the bibliographical meanings, but, are merely used by the inventor to enable a clear and consistent understanding of the present disclosure. Accordingly, it should be apparent to those skilled in the art that the following description of various embodiments of the present disclosure is provided for illustration purpose only and not for the purpose of limiting the present disclosure as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

For example, a touch screen device of an electronic device is a device that simultaneously performs an input function and a display function, and has a structure in which a touch panel to sense a touch input and a display panel to display a screen are integrated. The display panel of the electronic device may display a high-resolution (e.g., 1080*1920 or more for a device of 5 inches or less). On the other hand, the touch panel may sense a finger and/or a pen-touch, and, accordingly, a resolution to sense a touch input is not so high. However, it is necessary to increase a touch sensitivity of the touch panel. For example, it is suggested that a fingerprint sensor is built-in on a touch panel and an electronic device is activated by fingerprint sensing. Accordingly, the fingerprint sensor may be implemented independently with the touch panel. However, when a touch sensing resolution of the touch panel is increased, a fingerprint sensing function may be executed through the touch panel.

The electronic device according to an embodiment of the present disclosure suggests an apparatus and a method for implementing a display and a touch panel that has a resolution identical with or similar to a display resolution in the touch screen. To this end, a touch screen sensor of the electronic device has a structure in which a pattern of a touch sensor electrode senses a touch input regardless of a pixel location and is formed in a lower portion of a black matrix between pixels, and the touch sensor electrode is formed with the same density over an entire screen. That is, the touch screen sensor may be equipped with a color filter array for displaying a pixel and a sensor array for sensing a touch input. In addition, the color filter array may include pixel patterns which are disposed in an entire region of the screen, and black matrices including first black matrix lines which are disposed in a row (or column) direction between the pixel patterns, and second black matrix lines which are disposed in a column (or row) direction. Further, the row (or column) direction line is perpendicular to the column (or row) direction line. In addition, the sensor array is composed of first electrodes, which are disposed in a lower portion of the color filter and overlap a first black matrix line, and is composed of second electrodes, which are disposed in a lower portion of the pixel filter and overlap a second black matrix line. In addition, the first electrode and the second electrode have a size smaller than a width of the black matrix. Here, the black matrix line has a structure in which a gap is formed between pixels, and a black material is filled in this gap region. That is, a liquid crystal display (LCD), a light-emitting diode (LED) or an organic light-emitting diode (OLED) display includes a color filter to form a desired color by passing through a white light, and the color filter is manufactured by forming a black matrix line on a transparent substrate, and filling color (e.g., red (R), green (G) or blue (B)) ink into each color pixel divided by the black matrix line. Accordingly, the black matrix line may absorb an external light reflected from a display unit and improve a contrast.

In the below description, the black matrix line may be described as a black mask. In addition, the black matrix line may be formed between pixels or sub-pixels. When sensing a fingerprint by using the sensor array, the sensor array may fix and specify a fingerprint sensing region on a portion of a screen, and may be configured such that fingerprint sensing is performed in a whole region of the screen. In addition, a touch sensor (i.e., a fingerprint sensor) electrode is located between a thin film transistor (TFT) glass and a color filter glass, and the touch sensor electrode may be divided to individually operate when performing the fingerprint sensing, and may operate as a single touch sensor electrode by binding a plurality touch sensor electrodes when performing a finger and/or pen touch sensing function.

When the touch screen sensor is configured as described above, a solution for fingerprint sensing on the screen may be obtained, and, when it is applied to a full screen, a touch screen sensor having a high touch sensing resolution may be implemented.

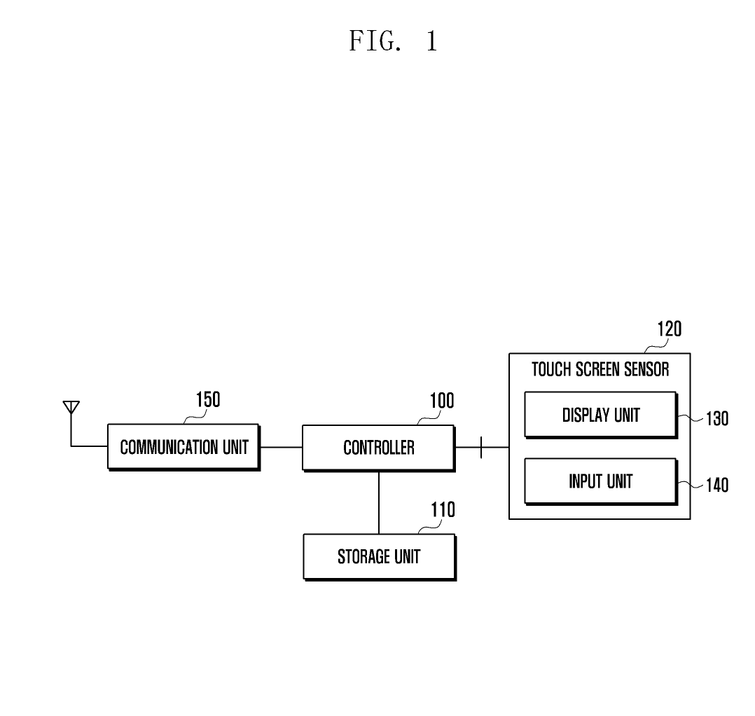

FIGS. 1 through 11, discussed below, and the various embodiments used to describe the principles of the present disclosure in this patent document are by way of illustration only and should not be construed in any way that would limit the scope of the disclosure. Those skilled in the art will understand that the principles of the present disclosure may be implemented in any suitably arranged communications system. The terms used to describe various embodiments are exemplary. It should be understood that these are provided to merely aid the understanding of the description, and that their use and definitions in no way limit the scope of the present disclosure. Terms first, second, and the like are used to differentiate between objects having the same terminology and are in no way intended to represent a chronological order, unless where explicitly stated otherwise. A set is defined as a non-empty set including at least one element.

FIG. 1 is a block diagram illustrating a configuration of an electronic device having a touch screen sensor according to an embodiment of the present disclosure.

Here, the electronic device may be various digital devices such as a mobile phone including a smart phone, a camera device, an MP3 device, a tablet computer, and a laptop computer.

Referring to FIG. 1, a touch screen sensor 120 may include a display unit 130 and an input unit 140. The display unit 130 may display various information processed by an electronic device. The display unit 130 may be a display such as LCD, OLED, LED, or the like. The input unit 140 may generate a signal of a touch input related to an input for controlling an operation of the electronic device and to an input of data. Here, the touch input may include a normal touch input, such as a finger and/or pen touch, and a precise touch input, such as fingerprint sensing, that requires a high resolution of touch sensitivity.

As illustrated in FIG. 1, a controller 100 may control the overall operation of the electronic device, and in particular, control the touch screen sensor 120 to perform a normal touch input sensing such as a finger and/or pen touch, and a precise touch input sensing such as fingerprint sensing, or the like.

Referring to FIG. 1, a storage unit 110 may include a program memory configured to store an operation program of the electronic device and a program according to an embodiment of the present disclosure, and may include a data memory configured to store processed information.

As illustrated in FIG. 1, a communication unit 150 may perform a wireless communication function with a base station or an internet server, or the like. Here, the communication unit 150 may include a transmitter configured to up convert a frequency of a transmission signal and amplify a power, and a receiver configured to low-noise amplify a reception signal, and down convert a frequency. In addition, the communication unit 150 may be provided with a modulation unit and demodulation unit. Accordingly, the modulation unit modulates the transmission signal to transmit to the transmitter, and the demodulation unit demodulates a signal received through the receiver. The modulation and demodulation unit may be Long Term Evolution (LTE), Wideband Code Division Multiple Access (WCDMA), Global System for Mobile Communications (GSM), or the like, and may be WIFI, Worldwide Interoperability for Microwave Access (WIMAX), or the like, and may be Near Field Communication (NFC), Bluetooth, or the like. In the present embodiment of the present disclosure, it is assumed that the communication unit 150 is equipped with a communication component, such as LTE, WIFI, Bluetooth, NFC, or the like.

In the electronic device having the above mentioned configuration, the touch screen sensor may include the display unit 130 and the input unit 140 for sensing a touch input. In the following explanation, the input unit 140 is described as a touch sensor, and the touch sensor 140 may sense a touch (hereinafter, it can be used interchangeably with a term “a first touch”) of a finger and/or a pen, and sense a touch (hereinafter, it can be used interchangeably with a term “a second touch”) to sense detail information according to a touch. Here, it is assumed that the second touch is a touch for fingerprint sensing.

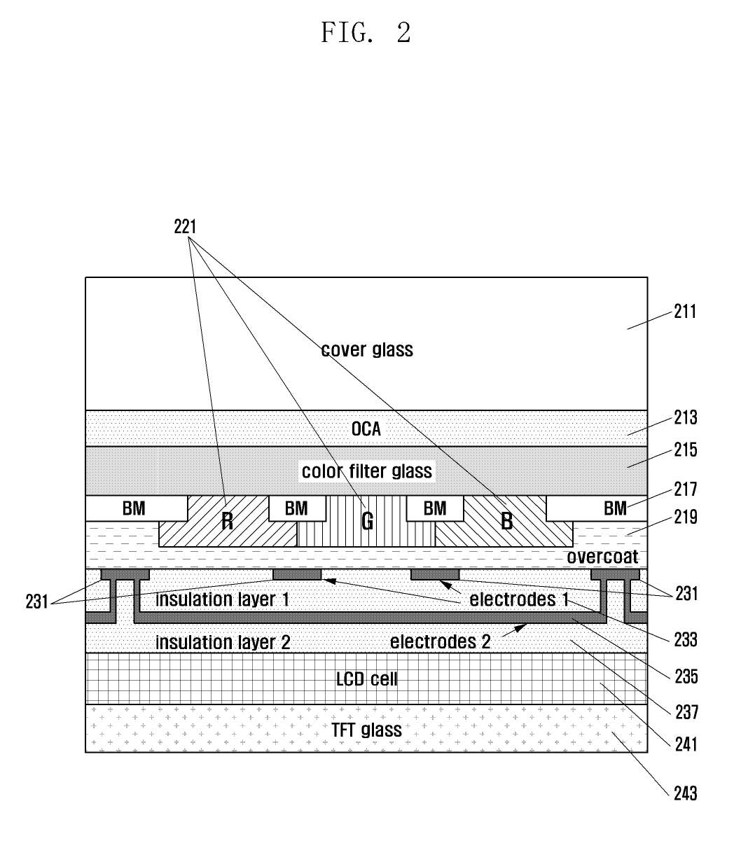

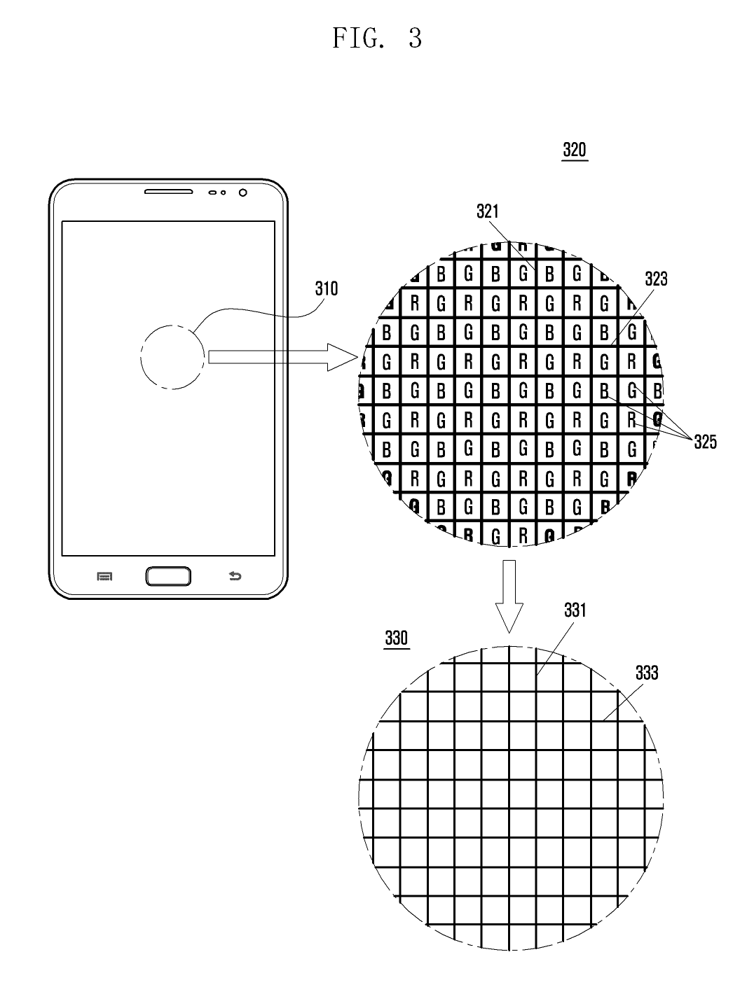

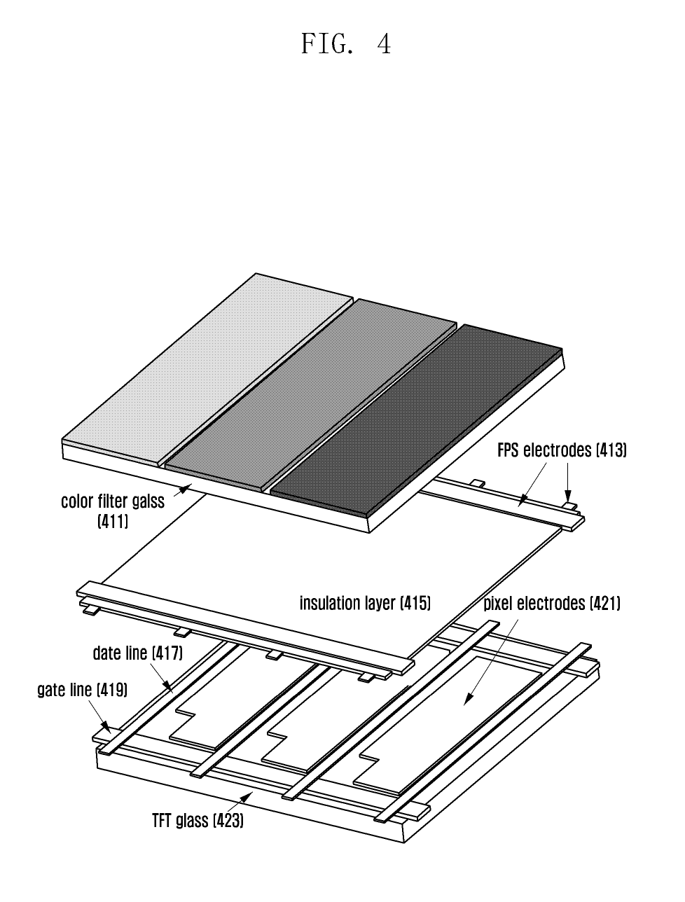

FIG. 2 is a side view of an electrode structure of a touch screen sensor according to an embodiment of the present disclosure, FIG. 3 is a diagram illustrating a structure of a color filter and a black matrix of a screen sensor according to an embodiment of the present disclosure, and FIG. 4 is a diagram illustrating a structure of an electrode layer of a screen sensor according to an embodiment of the present disclosure.

Referring to FIGS. 2 to 4, a fingerprint sensing method using the touch sensor may be implemented by a swipe type or a fixed region type. Here, the swipe type is a method of dragging a location specified in the screen by a finger, and a method of sensing a dragged finger (i.e., a fingerprint) in the touch sensor electrode which is disposed linearly or in one-dimension, and then, synthesizing the sensed finger as a two-dimensional fingerprint image through processing. In addition, the fixed region type is a method of obtaining a two-dimensional fingerprint image while touching a finger to the touch sensor disposed in two-dimensions. Therefore, the touch sensor to sense a fingerprint should be disposed with a one-dimensional or a two-dimensional electrode.

The touch screen sensor according to an embodiment of the present disclosure may dispose a touch sensor array between a pixel cell array and a color filter array. The pixel cell array may be composed of LCD, OLED or LED cells. In the embodiment of the present disclosure, it is assumed that the pixel cell array is composed of LCD cells.

Specifically, FIG. 2 shows an electrode structure of a touch sensor disposed in two-dimensions.

Referring to FIG. 2, an Optically Clear Adhesive (OCA) 213 is provided between a cover glass 211 and a color filter glass 215, sensor electrodes 231 (e.g., first electrodes) and 235 (e.g., second electrodes) may be disposed between an LCD cell 241 and the color filter glass 215. The LCD cell 241 is a part in which a liquid crystal is located between an LCD TFT glass 243 and a color filter glass 215, and an electrode of the touch sensor according to an embodiment of the present disclosure may be disposed onto the LCD cell 241, and disposed under a lower surface of the color filter glass 215 by utilizing a method of depositing an electrode. Color filters 221 may include R, G, B filters, and the color filters 221 may be separated by a black matrix 217 (e.g., BM). The black matrix 217 may be a gap between color filters 221 R, G, B, when the gap is filled with a black material. The black matrix 217 may absorb an external light reflected from the screen sensor, and improve a contrast by removing color interference between colors. Here, the touch sensor electrodes 231 and 235 may be disposed between the color filters 221 and the LCD cell 241, and may be disposed under the bottom of the black matrix 217 in the same matrix structure. The width of the sensor electrodes 231 is made to be less (so as to have a slightly smaller width) than the width of the black matrix 217 so that the sensor electrodes 231 are not seen when the user looks at the screen.

Referring to FIG. 2, the LCD cell 241 may include a pixel electrode, a gate line and data lines to drive the pixel electrode, and a liquid crystal. In addition, the touch sensor array may include the first electrodes 231 and the second electrodes 235 for sensing a touch, a first insulation layer 233 that insulates the first electrodes 231 and the second electrodes 235, and a second insulation layer 237 that insulates the second electrodes 235 and the LCD cell 241. An overcoat layer 219 may be provided between the insulation layer 233 and the color filters 221 and between the insulation layer 233 and the black matrix 217. In addition, a color filter array may include the color filters 221 to express pixels by a pixel array and the black matrices 217 to express pixels by forming a gap between the color filters.

In addition, the electrodes 231 and 235 of the touch sensor are made of metal electrodes of two layers to make a two-dimensional electrode structure, and the insulation layers 233 and 237 of two layers are disposed to insulate the electrodes 231 and 235. Here, the first insulation layer (e.g., insulation layer 1) 233 may serve to insulate the first electrodes (e.g., electrodes 1) 231 and the second electrodes (e.g., electrodes 2) 235, and the second insulation layer (e.g., insulation 2) 237 may serve to separate the second electrode 235 and the LCD cell 241. A via hole may be formed in the first insulation layer 233 disposed between two electrode layers of the first electrodes 231 and the second electrodes 235 so that the two electrode layers may be connected in a part which is necessary according to a configuration of the electrode.

Specifically, FIG. 3 illustrates an electrode configuration of a touch sensor disposed in the touch screen sensor. Referring to FIG. 3, a structure 320 may be obtained by expanding a partial screen 310 of a display unit. In the structure 320, reference numerals 325 may be the color filters 221 (see FIG. 2), and black matrix lines 321 and 323 may be a gap, which is formed between the color filters 221, filled with a black material. In addition, the black matrix line 321 may be a black matrix line arranged in a column direction (vertical direction), and the black matrix line 323 may be a black matrix line arranged in a row direction (horizontal direction). The electrode of the touch sensor may be disposed to have an arrangement identical with an arrangement of black matrix line. That is, referring to FIG. 3, an electrode 331 may be located under a bottom of the black matrix line 321, and an electrode 333 may be located under a bottom of the black matrix line 323. A width of the electrodes 331 and 333 should be smaller than a width of the black matrix lines 321 and 323.

As described above with reference to FIG. 2, in the touch screen sensor, the color filter array may include the color filters 221 disposed in an entire region of the screen, and black matrix lines, formed as a gap between the column and the row of the color filters 221, disposed in row and column directions. In addition, the touch sensor array may include the electrodes 231 and 235 which are disposed to overlap with an arrangement of the row and column black matrices under the bottom of the color filters 221. Assuming that the column direction is a first direction, and the row direction is a second direction, the first electrodes 231 may be disposed under the bottom of the first black matrix line 321, and the second electrodes 235 may be disposed under the bottom of the second black matrix line 323, and the width of the first electrodes 231 and the second electrodes 235 may be less than the width of the black matrix lines 321 and 323.

Referring to 330 of FIG. 3, the electrode 331, such as the first electrode 231 of FIG. 2 and the electrode 333, such as the second electrode 235 of FIG. 2 may be configured with a two-dimensional structure because the two electrodes 331 and 333 are perpendicular to each other, and the first insulation layer 233 of FIG. 2 may be formed between the first electrode 231 and the second electrode 235, and the second insulation layer 237 of FIG. 2 may be formed between the second electrode 235 and the LCD cell 241 of FIG. 2. In addition, the first electrode 231 and the second electrode 235 may be formed by metal wires, and be formed in parallel with the black matrix 217 of FIG. 2 while having a size that does not cover the color filters 221.

FIG. 4 is a diagram illustrating a three-dimensional structure of a touch screen sensor, where the LCD cell part is omitted.

Referring to FIG. 4, pixel electrodes 421 and a TFT for controlling a screen may be located on a TFT glass 423. The electrode structure of the touch sensor for fingerprint sensing may be configured of one or more electrode layers 413 and one or more insulation layers 415 on a lower surface of a color filter glass 411. FIG. 2 shows an example of the touch sensor configured of two electrode layers and two insulation layers. The electrodes of the touch sensor for fingerprint sensing may be disposed under a bottom of a black matrix between color filters so that the pixel may not be covered. As shown in a plan view, it can be disposed in the same location as gate line 419 and data line 417 which are placed on top of the TFT glass 423 to control a pixel. The width of the electrodes of the touch sensor may be implemented to be slightly less than the width of the data line 417 and the gate line 419 which are overlapped in the plan view so that the pixel may not be covered.

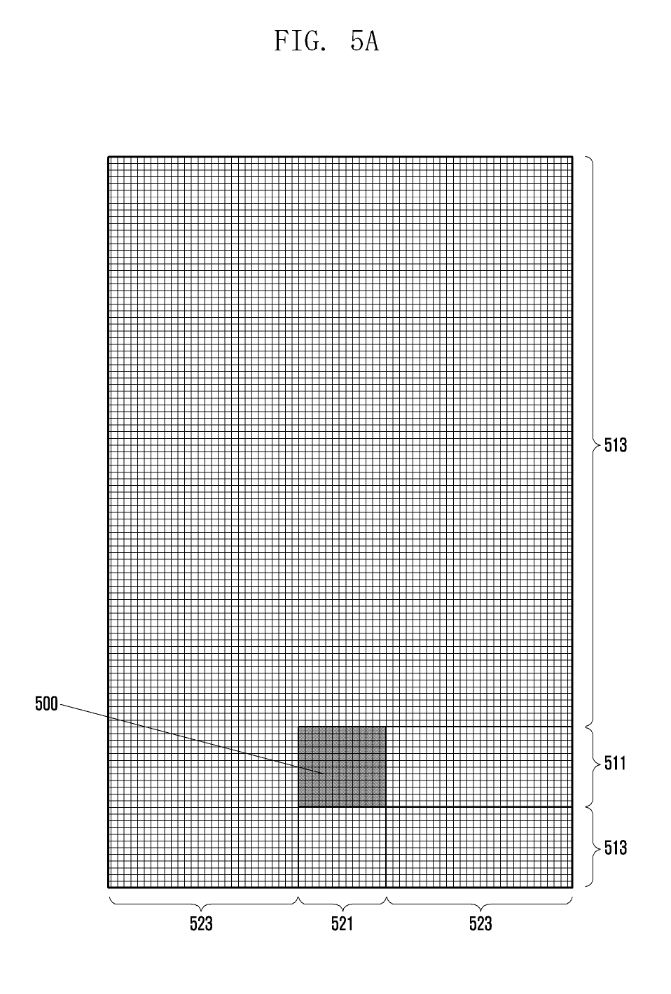

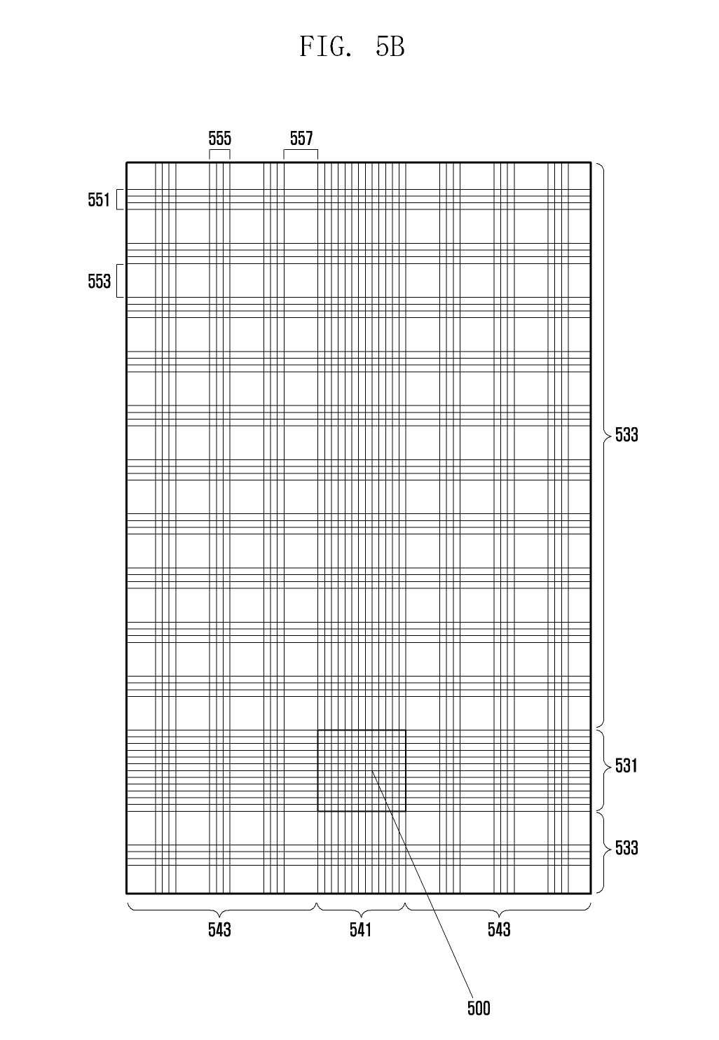

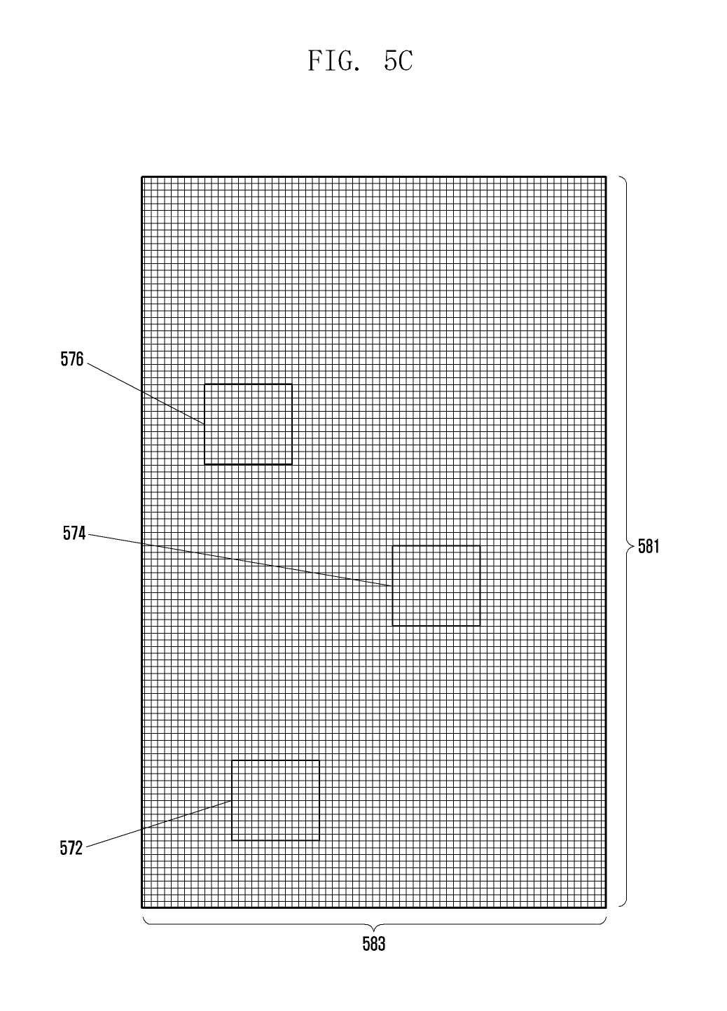

FIGS. 5A, 5B, and 5C are diagrams illustrating a location of fingerprint sensing in a touch screen sensor according to various embodiments of the present disclosure.

When fingerprint sensing is performed by using the touch sensor, the electrode of touch sensor may be configured in the form of x-y grid as shown in FIG. 3. If the fingerprint sensing is performed by using the touch sensor, the electrode of touch sensor should be disposed with a spacing which is smaller than a size and a width of the valley and ridge of fingerprint. This means that hundreds of electrodes are disposed in the form of crossing within a contact region (e.g., 10 mm×10 mm) of the finger. As the number of the pixel of the screen is increased, the spacing between pixels or the spacing between electrodes formed on the BM is less than several tens of micrometers, such that the touch screen sensor has a sufficient spacing for fingerprint sensing. However, as the density of the electrodes of the touch sensor for fingerprint sensing is increased, the number of wirings (routing) for connecting the electrodes to the controller 100 of FIG. 1 (a sensor controller for controlling a touch sensor) should be also increased to properly arrange routing.

Further, the fingerprint sensing location may be fixed as shown in FIGS. 5A and 5B, and may be an entire region of the touch sensor as shown in FIG. 5C.

Referring to FIG. 5A, when performing fingerprint sensing, the electrode of touch sensor should be arranged with a small spacing which is smaller than the spacing of the ridge and valley of fingerprint. Therefore, the increase of the number of the electrodes and the electrode routing required for the fingerprint sensing may be minimized by fixing a region for fingerprint sensing, and disposing the electrode with a density necessary for the fingerprint sensing only in a location of a fixed region for fingerprint sensing as shown in FIG. 5A. Further, since the electrode of the fingerprint sensing may be installed to be identical with the BM, the density of the electrode for fingerprint sensing may be disposed with a pixel density over an entire screen, and or may be disposed with a pixel density only in a fixed region. FIG. 5A illustrates an example in which, by a former method, an electrode of the touch sensor is disposed with the same density over an entire screen and a routing of electrode is differently arranged only in a part which is necessary for fingerprint sensing to decrease a load of arrangement due to the routing.

Referring to FIG. 5A, a region of reference numeral 500 may be a fixed region for fingerprint sensing, and the region 500 may be a place in which the electrode of the touch sensor is disposed to have a density identical with the density of pixel, and may be a location in which fingerprint sensing is able to be performed on the screen. In addition, reference numeral 511 may be a drive line (or a sensing line to sense a drive signal) to drive a signal for sensing the touch of the region 500, and reference numeral 521 may be a sensing line (or a drive line) to sense the touch of the region 500. Here, the drive line may be called as a drive channel or a sensing port. In addition, the sensing line may also be called as a sensing channel or a sensing port. In addition, in the region other than the region 500, the electrode density of the touch sensor is identical with the electrode density of the touch sensor in the region 500, but, when routing is implemented, multiple electrodes are bound to be provided to the sensor controller.

That is, the region other than the region 500 is a region for sensing a finger and/or pen touch, and, in this region, not all of drive lines (or sensing lines) 513 and sensing lines (or drive lines) 523 may be used, but may be used as a drive line and a sense line while skipping every unit of a certain number of electrodes. That is, when using the lines 513 as a drive line, the controller 100 of FIG. 1 may apply a drive signal to N electrode lines while interlacing (i.e., not using lines) a unit of M first electrodes, and may sense X second electrode lines used as a sensing line while interlacing (i.e., not sensing a drive signal) a unit of Y second electrode lines which are not used as a sensing line when using the lines 523 as a sensing line.

Accordingly, when a region for fingerprint sensing is fixed to be used as shown in FIG. 5A, each electrode line of the electrodes located in the region of 500 may be operated as an individual channel and perform fingerprint sensing, and the electrodes located in the other region may skip by every unit of set electrode lines and be used as a drive line and a sensing line for sensing a finger and/or pen touch input.

Generally, since the fingerprint sensing is used only at steps for authentication, secure authentication, or the like to unlock a lock screen, it is not continuously used like the finger and/or pen touch, but is used at a restricted time and step, and, accordingly, may be configured to be restricted to a natural location in consideration of user interface (UI) as shown in FIG. 5A and be specified on the screen to be used.

FIG. 5B is a diagram illustrating another structure of a touch sensor having a fixed fingerprint sensing region according to an embodiment of the present disclosure.

Referring to FIG. 5B, a specific region of the touch sensor may be fixed as a fingerprint sensing region 500. The region 500 fixed as the fingerprint sensing region is a place where the electrode of the touch sensor is disposed to have a density identical with the density of the pixel in the same manner as FIG. 5A, and may be a location in which the fingerprint sensing region is able to be performed on the screen. In addition, reference numeral 531 may be a drive line (or a sensing line) to sense the touch of the region 500, and reference numeral 541 may be used as a sensing line (or a drive line) to sense a touch of the region 500. In addition, the number of the drive line and the sense line may be the number of the first electrode and the second electrode that exist in the region 500.

In addition, the region other than the region 500 is a region to sense a fingers and/or pen touch, and may be configured differently from the density of the region 500 and the electrode of touch sensor. Therefore, when configuring the electrode of the touch sensor, the first electrode and the second electrode may be disposed with a size and a spacing that can sense the finger and/or pen touch, but, in the other region, electrodes are not disposed. Reference numerals 551 and 555 are a region in which the electrode of the touch sensor is disposed, and reference numerals 553 and 557 are a region in which the electrode of the touch sensor are not installed. That is, in the region of the touch sensors other than the fingerprint sensing region 500, the first and second electrodes may be disposed in a section of a region 551 (e.g., a spacing of N electrodes) and a region 555 (e.g., a spacing of X electrodes) while interlacing by a section unit of a region 553 (e.g., a spacing of M electrodes) and a region 557 (e.g., a spacing of Y electrodes), and the controller 100 of FIG. 1 may apply a drive signal to sense the regions 551 and 555, and sense the driven signal. When performing drive and sense operations through lines of the region 551 and the region 555, the controller 100 may use an entire line, or may use only one or more line of the entire line. The number of the electrodes disposed in the regions 551 to 557 may be variously set such as N≠M≠X≠Y, N=X or M=Y, N=M=X=Y, and the like.

In addition, FIG. 5B illustrates that, in the region other than the region 500, not all of drive lines (or sensing lines) 533 and sensing lines (or drive lines) 543 may be used, but may be used as a drive line and a sense line while skipping every unit of a certain number of electrodes.

FIG. 5C is a diagram illustrating an electrode arrangement in which an entire region of a touch sensor may be used as a touch region for fingerprint sensing and a fingers and/or pen touch according to an embodiment of the present disclosure.

Referring to FIG. 5C, electrodes 581 and 583 may be disposed in an entire region of the touch sensor and may be disposed to have a density identical with the density of the pixel. The controller 100 of FIG. 1 may perform drive and sense operations of all electrodes disposed in the entire region of the touch sensor. Unlike FIG. 5A, the controller 100 may arbitrarily determine a location of fingerprint sensing, and, accordingly, the fingerprint sensing may be able to be performed in an arbitrary location on an entire screen. That is, in FIG. 5C, the sensor electrode for the fingerprint sensing in the screen may be identically disposed as shown in FIG. 5A, and the controller 100 may connect the routing to drive and sense the entire region of the touch sensor. As shown in FIG. 5C, the fingerprint sensing may be able to be performed in any location (e.g., 572, 574, 576, or the like).

Sometimes the fingerprint sensing may be used only when an electronic device is initially started, or a security authentication is required. Therefore, the controller 100 may sense an event that requires fingerprint sensing and an event that does not require the fingerprint sensing. Therefore, when the fingerprint sensing is performed, the fingerprint is sensed by driving and sensing all of the electrodes of the touch sensor. In addition, in a section that does not require the fingerprint sensing, drive and sense operations may be performed by binding multiple electrode lines in a location in which a touch of a large scale object (finger and/or pen) is sensed like the drive and sense operations of FIGS. 5A and 5B.

Referring to FIGS. 5A, 5B, and 5C, the electrodes of the touch sensor may be disposed to have a density identical with the density of pixel or may be disposed to be identical with the density in a partial region, and a fingerprint sensing method may be performed by a fixed type or a variable type.

That is, the fingerprint sensing method of FIGS. 5A and 5B may be performed in a fixed location in the screen, the controller 100 may dynamically change a switching to an individual drive or a binding drive of electrode line according to a touched object in a fixed region, and may sense the finger/pen touch with a binding drive in touch sensor region other than the fingerprint sensing region. In addition, in the fingerprint sensing method of FIG. 5C, the entire electrode of the screen may be always operated as an individual drive in a scale for fingerprint sensing. Accordingly, there may be no dynamic change using a switch, but the individual drive may always be performed. Accordingly, it is possible to perform a precise touch sense which has a fingerprint sensing level in the entire location of screen. In addition, in the case of FIG. 5C, in the operation of sensing a finger/pen touch, the electrodes may be driven and sensed by a binding drive.

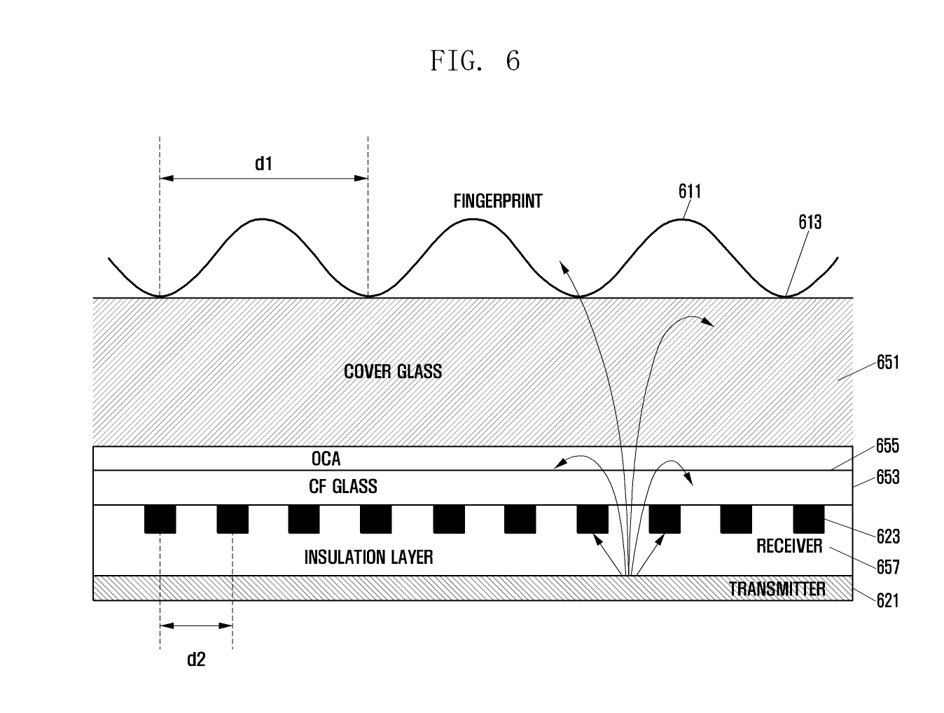

FIG. 6 is a side view of an electrode of a touch sensor, illustrating an operation of performing fingerprint sensing in a touch screen sensor according to an embodiment of the present disclosure.

Referring to FIG. 6, as described above in FIG. 2, in a layer structure for electrode arrangement, a cover glass 651 to protect a screen or a sensor, an OCA 655 to attach an LCD, a color filter (CF) glass 653, and an electrode layer for fingerprint sensing may be disposed from top down. In addition, the structure of a liquid crystal under the first and second electrodes 621 and 623 may be omitted for the sake of simplicity. In addition, the second electrodes 623 may be disposed in a second direction on a bottom of the black matrix of the color filter glass 653, the first electrode 621 may be disposed in a first direction on a bottom of the black matrix, a second insulation layer 657 may be formed between the first electrode 621 and the second electrodes 623, and a first insulation layer may be disposed between the second electrodes 623 and an LCD cell.

Moreover, the spacing of the first electrode 621 and the second electrodes 623 should be set smaller than the spacing of the ridge 611 and the valley 613 of fingerprint. That is, referring to FIG. 6, a spacing d2 of electrodes should be disposed to be smaller than a spacing d1 of the ridge 611 and the valley 613 of fingerprint. This is to sense accurately the ridge and the valley of a fingerprint of finger which is touched when a fingerprint is sensed.

Referring to FIG. 6, the first electrode 621 and the second electrodes 623 may be disposed to be perpendicular each other. In addition, the first electrode 621 and the second electrodes 623 may be divided into a transmitter electrode and/or a receiver electrode according to each function, and its location is not limited. That is, as shown in a drawing, the receiver electrode and the transmitter electrode may be disposed from the top, or may be disposed in a different order. In addition, when the controller 100 of FIG. 1 outputs a drive signal through the first electrode 621, the second electrodes 623 may sense a touch of the finger touched on the cover glass 651. When the finger touch is generated, capacitance varies in a direction from the first electrode 621 to the second electrodes 623, and thus, the controller 100 may sense a region touched by the finger through the second electrodes 623. Alternatively, when the finger touch is generated, due to a radio frequency (RF) impedance difference between a touched part and a part which is not touched, a difference of strength of RF electric field flowing into the second electrodes 623 from the first electrode 621 may be generated, and the controller 100 may sense a region touched by the finger through the second electrodes 623. Accordingly, since a spacing of the second electrodes 623 is d2 which is smaller than a spacing d1 between the valley 613 and the ridge 611 of the fingerprint, the controller 100 may sense a touch input of the valley 613 and the ridge 611 of the fingerprint.

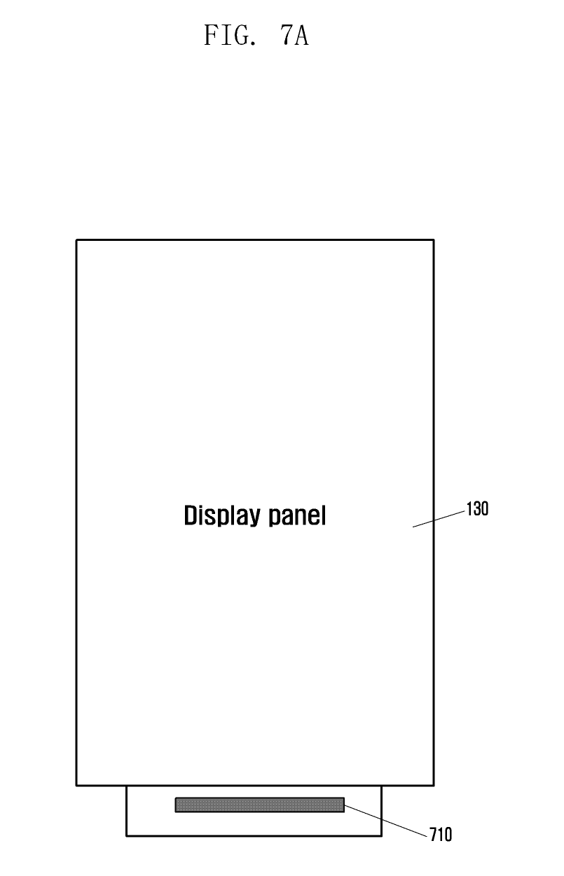

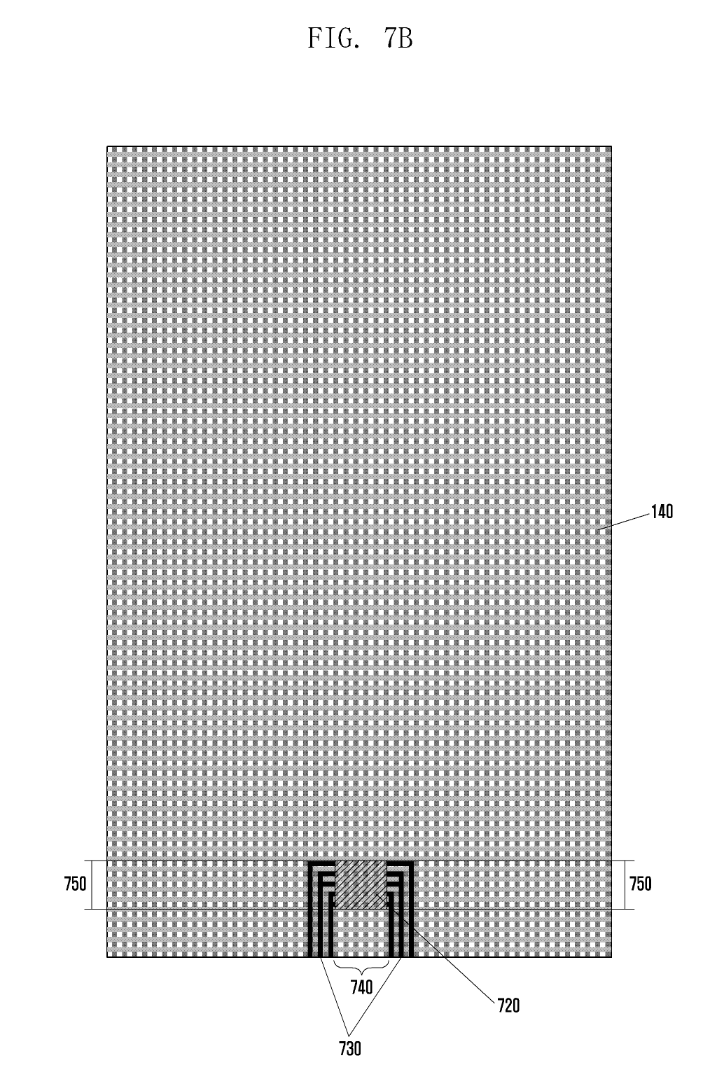

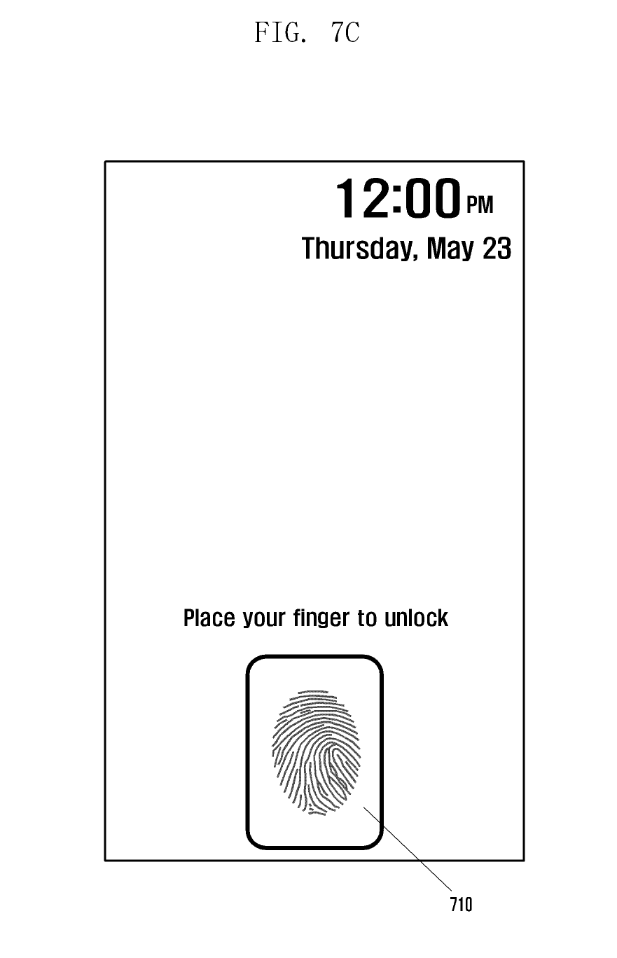

FIGS. 7A, 7B, and 7C are diagrams illustrating a configuration of an example of fixing and using a fingerprint sensing region in a touch screen sensor according to various embodiments of the present disclosure.

Specifically, FIG. 7A is a diagram illustrating an example of disposing a controller for fingerprint sensing, FIG. 7B is a diagram illustrating a routing of a fingerprint sensing region in an input unit 140 of a touch sensor, and FIG. 7C is a diagram illustrating an example of a UI display in a fingerprint sensing region indicated in a screen. Referring to FIGS. 7A to 7C, it is preferable that a controller 710 for fingerprint sensing in the touch sensor is fixed in an edge (up, down, left, or right side) of a display unit 130. This is to dispose the controller 710 for fingerprint sensing in nearest location to the controller 100 of FIG. 1 or to a sensor interface that interfaces with the controller 100 as a routing connected to the electrode is complicated. FIG. 7A illustrates an example in which the fingerprint sensing region may be disposed in a bottom region of the display unit 130 and the controller (e.g., integrated circuit (IC)) 710 including a circuit that interfaces the controller 100 and the touch sensor may be disposed in the bottom region of the display unit 130. However, FIG. 7A is just an example, and, as described above, it may be located anywhere such as up, down, left, or right side of the display unit 130.

When the fingerprint sensing region for performing fingerprint sensing is fixed in a specified location in the screen, as shown in FIGS. 5A and 5B, the electrodes for fingerprint sensing may be located in a center of the bottom of the screen as shown in FIG. 7B. In addition, the fingerprint sensing region may be set to a size of the fingerprint, and may be set, for example, to a size of 10 mm×10 mm. When the electrode of the touch sensor is disposed like FIG. 5B, the first electrode connected to the drive lines of the controller 100 may have a region in which the electrode is not disposed at regular intervals as shown in FIG. 5B. Therefore, when the electrode routing of fingerprint sensing region 720 is arranged, it may be divided into a region 750 which is used in common with a finger touch and a region 730 which is used only for fingerprint sensing. The routing of an electrode only for fingerprint sensing may be efficiently performed when it is disposed in a routing direction 740 of the second electrode as shown in 730.

FIG. 7C illustrates an example of a UI for displaying fingerprint sensing, when a fingerprint sensing region is disposed in a bottom of a center of screen as shown in FIG. 7B. The fingerprint sensing may be implemented in a location inside of a screen, not in a home key outside of a screen, a bottom apparatus, or a rear side, thereby smoothly linking to software UI for intuitive recognition, and authentication.

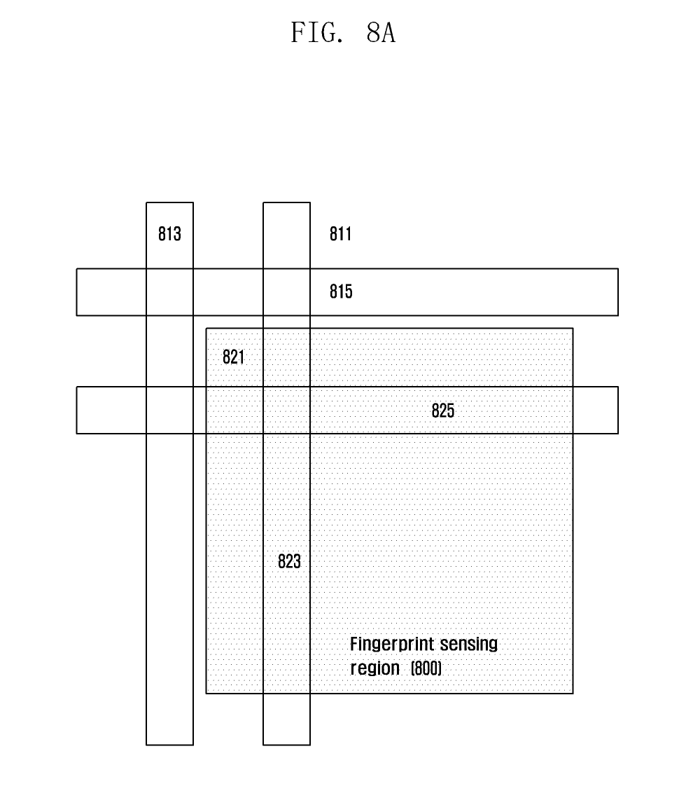

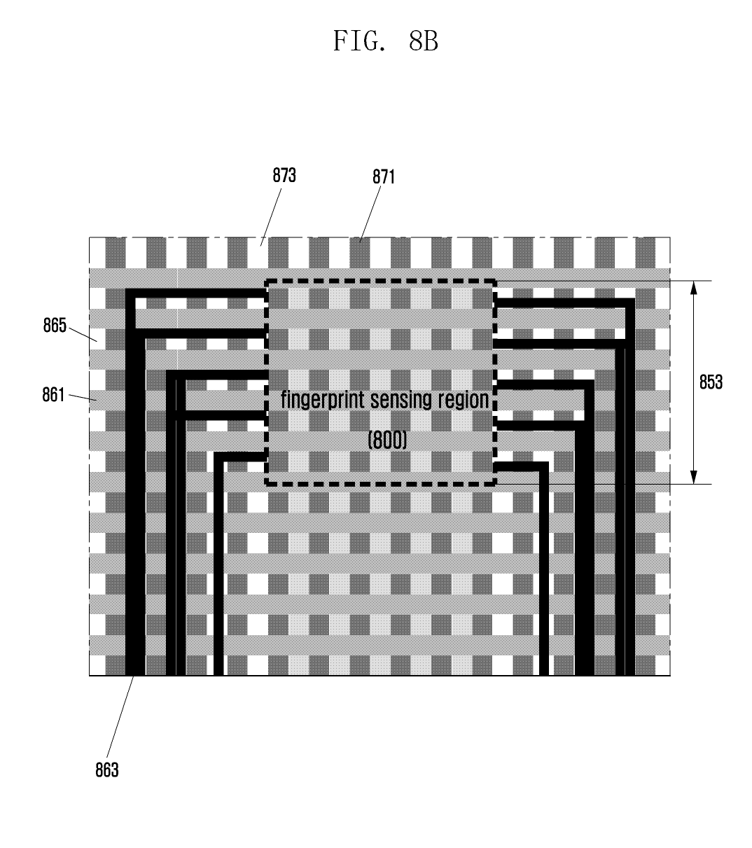

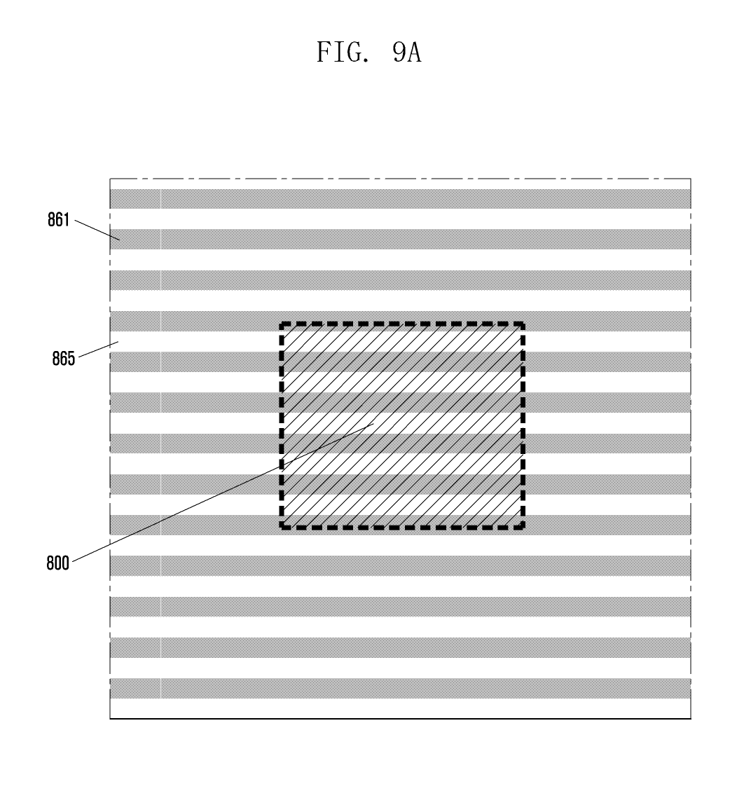

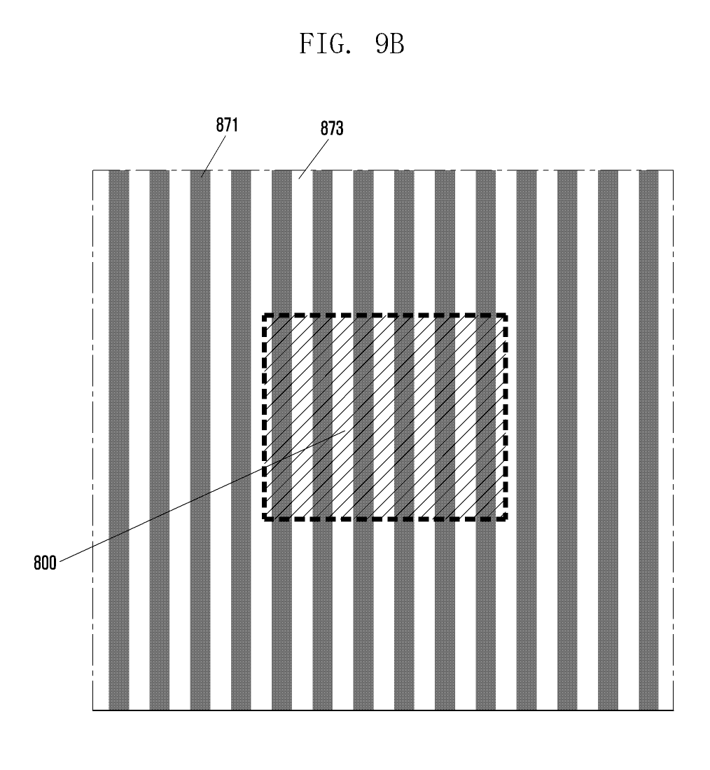

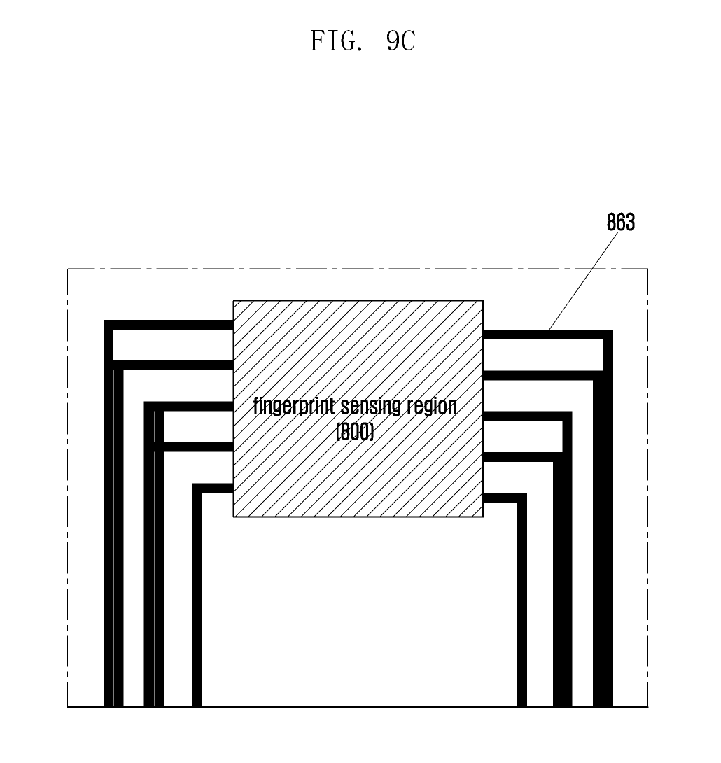

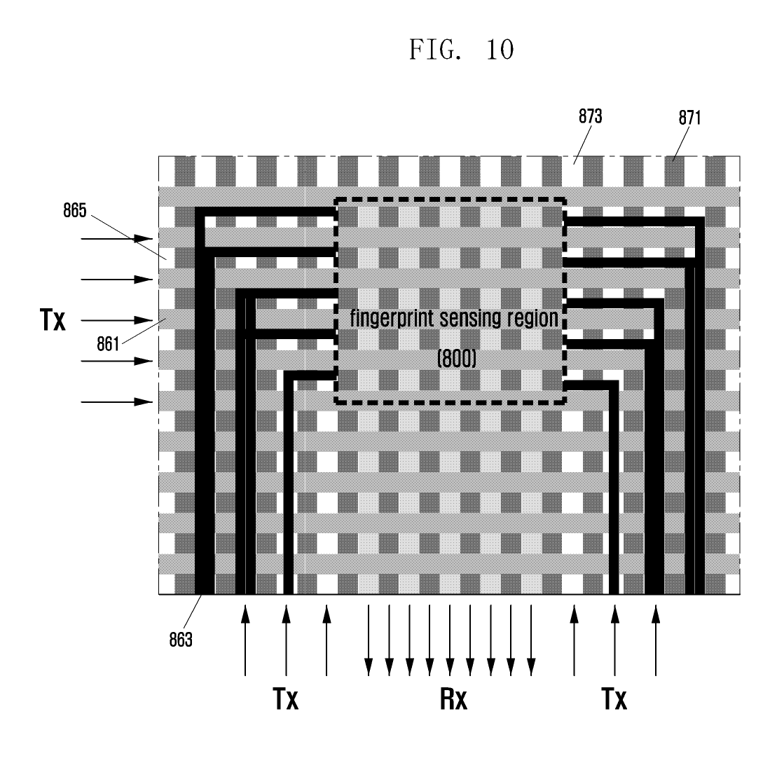

FIGS. 8A and 8B are diagrams enlarging and displaying a fingerprint sensing region in a screen according to various embodiments of the present disclosure, FIGS. 9A, 9B, and 9C are diagrams illustrating an example of an arrangement of a first electrode and a second electrode in a fingerprint sensing region according to various embodiments of the present disclosure, and FIG. 10 is a diagram illustrating an operation of applying a drive signal to electrodes disposed in a fingerprint sensing region, and sensing a driven signal according to an embodiment of the present disclosure.

Specifically, FIG. 8A is a diagram illustrating a function of electrodes of a fingerprint sensing region 800 in a screen according to an embodiment of the present disclosure. As described above, the fingerprint sensing region 800 should be able to sense a fingerprint and a finger/pen touch. However, when the fingerprint sensing region 800 is fixed to use, the touch sensor region may be configured to sense only the finger/pen touch in the other region except for the fingerprint sensing region 800. Therefore, the touch sensor is configured by disposing a region 811 which is not used, a vertical electrode (e.g., a second electrode) region 813, a horizontal electrode (e.g., a first electrode) region 815, an electrode 821 which is used only for fingerprint sensing, a vertical electrode 823 for both fingerprint and finger/pen sensing, and a horizontal electrode 825 for both fingerprint and finger/pen.

Referring to FIG. 8A, a method of dividing a role of an electrode of a fingerprint sensor within a screen is illustrated. As shown in FIG. 8A, the sensor electrodes of the fingerprint sensing region may be divided into seven regions based on each function. The region 811 is a part of void space as no electrode is installed in the BM of the pixel. In addition, in the regions 813 and 815, the electrodes are disposed in the outside of the fingerprint sensing region. The region 813 is a part which is able to operate like a single electrode by grouping respective electrodes formed along the BM of the pixel together, and is a sensor electrode that senses the finger/pen touch. In addition, the region 815 is a part which operates like the region 813, and is a horizontal electrode.

In addition, the region 821 is a fingerprint sensing-only region in which electrodes are formed in horizontal and vertical directions, and is a part in which respective electrode lines are individually divided and driven. The region 821 is a region in which operation can be switched to sense a large object such as a finger after the fingerprint sensing is terminated in the fingerprint sensing region 800. When the fingerprint sensing is conducted, respective electrode lines may operate individually as shown in the region 821, and, when the finger is sensed, respective electrode lines may operate like a single electrode as respective electrode lines are grouped together. In addition, when operation is switched to sense the fingerprint or the finger, a switch inside of the controller 100 of FIG. 1 or the sensor controller may be used. The region 825 is a region that performs the same function as the region 823, and the region 823 may be a vertical electrode, and the region 825 may be a horizontal electrode.

In the embodiment of the present disclosure, the routing of horizontal electrode of fingerprint sensing region may be disposed in a vertical direction in which the sensor electrode is not installed. In a method of routing the fingerprint sensing-only electrodes, after disposing the routing in a horizontal direction, the routing is changed in a vertical direction (i.e., a region in which sensor electrode is not installed) to be connected to the outside of the screen.

When the electrode is disposed as shown in FIG. 8A, the routing between the electrodes and the controller 100 may be lengthened. For example, assuming that the number of channels (i.e., the number of sensor electrode) to sense a finger/pen touch in an entire region of the touch sensor is 86*54, the controller 100 requires 140 channels in order to sense the finger/pen touch of the touch sensor. However, assuming that the region for the fingerprint sensing is 10.7 mm*10.7 mm, and, assuming that the number of channels (i.e., number of horizontal and vertical electrodes) of the fingerprint sensing is 160*160, the controller 100 requires a total 320 channels to sense the fingerprint in the fingerprint sensing region. Therefore, if the number of the channels for interfacing with the electrodes disposed in the fingerprint sensing region is increased, the routing for the interface between the controller 100 and the touch sensor is complicated. Therefore, as described above, the fingerprint sensing region should be set in a location adjacent to the controller 100 or a sensor interface unit that interfaces with the touch sensor. In addition, it is preferable that the length of routing between the electrodes for the interface and the interface unit is short.

Specifically, FIG. 8B illustrates an example of routing between a fingerprint sensing region 800 and an interface circuit according to an embodiment of the present disclosure.

In addition, since a region 861, in which horizontal electrodes (including electrode 863) are arranged in a fingerprint sensing region 800, is an electrode used for both the fingerprint and the finger/pen touch, the routing of the horizontal electrode 863 in the region 861 is disposed in a region 853. However, the routing of the horizontal electrode 863 used only for fingerprint sensing in the fingerprint sensing region 800 may be disposed in a vertical direction by extending to a region 873 which is not used as an electrode in a vertical direction, so as to shorten the routing of the horizontal electrode 863. That is, a region 871 in which the electrode is disposed in a vertical direction is a region in which the electrode is disposed in order to sense the finger/pen touch. However, since the vertical region 873 is a region which is not used in the finger/pen touch, it is not necessary to dispose a vertical electrode. In addition, a horizontal region 865 is a region which is not used in the finger/pen touch making it not necessary to dispose a horizontal electrode. Therefore, the routing of the horizontal electrode dedicated to the fingerprint sensing in the fingerprint sensing region 800 may be performed by using the horizontal region 865 and the vertical region 873 and be connected to the interface unit.

FIGS. 9A, 9B, and 9C are diagrams illustrating an example of an arrangement of a first electrode and a second electrode in a fingerprint sensing region according to an embodiment of the present disclosure.

FIG. 9A illustrates an example of a horizontal electrode and a routing of a touch sensor according to an embodiment of the present disclosure.

Referring to FIG. 9A, a fingerprint sensing region 800 and regions 861 and 685 are illustrated. According to FIG. 9A, the horizontal electrode may be disposed in the region 861 in order to sense the finger/pen touch, and may not be disposed in the region 865.

FIG. 9B illustrates an example of a vertical electrode and a routing of a touch sensor according to an embodiment of the present disclosure.

Referring to FIG. 9B, the vertical electrode may be disposed in region 871 in order to sense the finger/pen touch, and may not be disposed in region 873. In the fingerprint sensing region 800, the horizontal and vertical electrodes should be installed with a density identical with a pixel density in order to sense the fingerprint. Therefore, when the fingerprint sensing region is installed in a bottom center of the screen, the routing of the vertical electrodes may be extended to the bottom center of the screen and may be connected to the interface unit which is not shown. However, the routing of the horizontal electrode may have a complex structure for connecting to the interface unit.

Therefore, as illustrated in FIG. 9C, a horizontal electrode 863 dedicated to fingerprint sensing may be turned in a region other than the fingerprint sensing region 800 and be disposed in a vertical direction. The routing of horizontal electrode of the fingerprint sensing region 800 may be connected in a vertical direction as shown in reference numeral 863 by using the region 865 of FIG. 9A in which the horizontal electrode is not installed and the region 873 of FIG. 9B in which the vertical electrode is not installed.

FIG. 10 is a diagram illustrating an operation of applying a drive signal to electrodes disposed in a fingerprint sensing region and sensing a driven signal according to an embodiment of the present disclosure.

Referring to FIG. 10, a horizontal electrode (e.g., a first electrode) may be connected to drive lines, an electrode for sensing both the fingerprint and the finger may be disposed in a side in the fingerprint sensing region 800, and the fingerprint sensing-only electrode may be disposed by using a region which is not used as an electrode in a vertical direction. In addition, the vertical electrode may be connected to a sensing line, and may be disposed in a vertical direction. Therefore, in the electrodes of the fingerprint sensing region, the routing of the electrodes to apply drive signals and sense a driven signal may be efficiently performed.

Referring to FIG. 10, the fingerprint sensor may be disposed in the bottom center of the screen, and the fingerprint sensor may be an area type sensor which has 160 channels in a horizontal direction, and 160 channels in a vertical direction. When the fingerprint sensor is configured of a swipe type, the number of horizontal electrodes may be significantly reduced (e.g., 10 or less in a fingerprint sensing region) by setting the vertical direction as a swipe direction. When the electrode is disposed on the routing arrangement region dedicated to the fingerprint sensor electrode, the 160 electrodes in the vertical direction are set to be directly connected in a downward direction. In addition, the 160 electrodes in the horizontal direction may be divided into a part 863 in which the routing is connected downwardly and a part 861 in which the routing is connected in a horizontal direction. Accordingly, as the routing is divided in two directions, the region occupied by the routing may be divided.

FIG. 10 illustrates a vertical electrode disposed in region 871 in order to sense the finger/pen touch, region 873 in which the vertical electrode is not disposed, and a horizontal region 865 which is a region which is not used in the finger/pen touch.

The fingerprint sensor may be functionally divided into a transmitter (Tx) or a receiver (Rx). FIG. 10 illustrates an example in which the transmitter (Tx) is connected in a horizontal direction, and the receiver (Rx) is connected in a vertical direction. However, the arrangement of the transmitter (Tx) and the receiver (Rx) is just an example, and may be disposed reversely. Since the fingerprint sensor has an electrode of fine line width to fit the scale of fingerprint, a resistance due to an electrode connection may be varied according to a form of routing arrangement, and may be varied according to a channel. Accordingly, when the electrode routing of the fingerprint sensor is shortened as shown in FIG. 10, a variation of the resistance may also be reduced.

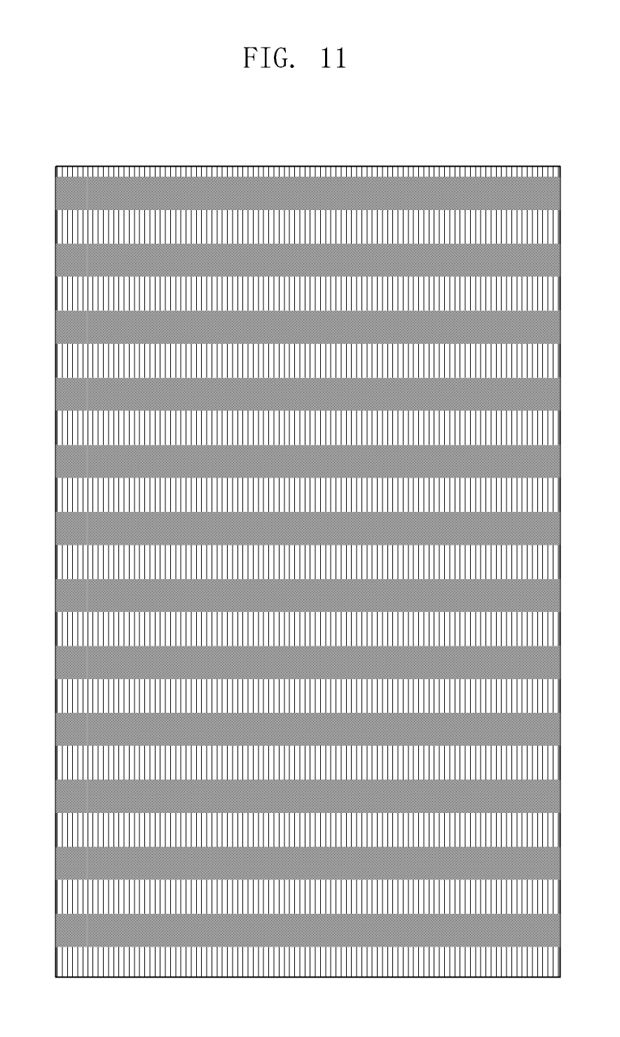

FIG. 11 is a diagram illustrating an example of sensor electrode routing when a touch sensor for fingerprint sensing is configured as a swipe type in a touch screen sensor according to an embodiment of the present disclosure. In FIG. 11, it is assumed that the direction of the swipe is a vertical direction.

Referring to FIG. 11, if the direction of the swipe is a vertical direction, a number of horizontal electrodes may be reduced significantly as compared with FIG. 10. That is, in the case of the fingerprint sensor of swipe type, the electrode is disposed only in a downward direction (Y-direction), and only a few receiver electrodes (about 1 or 2) are disposed in an X direction. Accordingly, in the fingerprint sensor of FIG. 9C, the electrode of region 863 is not necessary. For example, the fingerprint sensor of a fixed region of FIG. 10 requires 160 sensor electrodes in an X direction, whereas the fingerprint sensor of swipe type has 10 or less sensor electrodes in an X direction. Accordingly, the number of routing for the X direction sensors may also be decreased as much.

Therefore, as described above, when the electrodes of the touch sensor in the touch screen sensor are installed in a bottom region of the black matrix, the touch sensor may be configured without detriment to the transmittance of the screen through the black matrix, and the transmittance of a touch screen according to the related art may be improved as ITO film is not used. In addition, in case of the LCD, a metal wire (e.g., a Cu wire) under a CF glass may be used as an electrode, so that a decrease in electrode resistance is not so large as compared to a FPCB type fingerprint sensor. In addition, a specific region of the screen may be used as the fingerprint sensing region, or an arbitrary region within the screen may be used to sense a fingerprint. In addition, a driving circuit for operation of a fingerprint sensor may be applied to entire channels of screen by using a dynamic channel switching to operate as a touch screen. Accordingly, a touch screen in the touch screen sensor may be implemented by a composite panel that can perform fingerprint sensing, a screen touch, and hovering sensing.

As described above, when implementing a touch screen of electronic device, electrodes of touch sensor are formed in a bottom of a black matrix line of display panel, such that a touch screen device having a high resolution may be implemented without detriment to a transmittance of screen. In addition, when a fingerprint sensor is built in the touch screen, a metal wire (e.g., Cu wire) is used as an electrode in a bottom of a color filter glass of display, such that a reduction of electrode resistance is not so large compared to a fingerprint sensor of an FPCB type that can be used outside of the screen. Further, the touch screen device may use a specific region of the screen as a fingerprint sensing region or may use an arbitrary region within the screen to enable to perform fingerprint sensing. In addition, when a drive circuit for operation of fingerprint sensor is applied to all channels of a screen by using a dynamic channel switching, it may be operated as a touch screen. That is, a touch screen device of composite panel that can perform all of fingerprint sensing, a screen touch, and a hovering sensing may be implemented.

While the present disclosure has been shown and described with reference to various embodiments thereof, it will be understood by those skilled in the art that various changes in form and details may be made therein without departing from the spirit and scope of the present disclosure as defined by the appended claims and their equivalents.

What is claimed is:

1. A touch screen apparatus having a fingerprint sensing function, the touch screen apparatus comprising:
a color filter layer including a first black matrix line, which is located between each of pixels or each of sub-pixels and is arranged in a first direction, and including a second black matrix line, which is arranged in a second direction that is perpendicular to the first direction;
a thin film transistor (TFT) layer including a gate line and a data line; and
a sensor layer located between the color filter layer and the TFT layer, the sensor layer including a first electrode, which is spatially arranged with the first black matrix line, and including a second electrode, which is spatially arranged with the second black matrix line.

2. The touch screen apparatus of claim 1, wherein the first electrode and the second electrode are electrically isolated.

3. The touch screen apparatus of claim 1, wherein the first electrode and the second electrode are comprised of a metal wire.

4. The touch screen apparatus of claim 1, further comprising a display region including a first region and a second region,
wherein the first region of the display region is configured to recognize a fingerprint and to sense a touch of an object, and
wherein the second region of the display region is configured to detect a touch of an object.

5. The touch screen apparatus of claim 4, wherein an array density of the first electrode and the second electrode in the first region is greater than an array density of the first electrode and the second electrode in the second region.

6. The touch screen apparatus of claim 4, wherein M first electrodes are configured as a single drive line and N second electrodes are configured as a single sensing line to sense a touch of an object.

7. The touch screen apparatus of claim 1, wherein the sensor layer comprises:
a first insulation layer formed between the first electrode and the second electrode; and
a second insulation layer formed between the second electrode and a TFT glass.

8. The touch screen apparatus of claim 7, wherein the first electrode and the second electrode are formed of a metal wire, and are formed parallel to a black matrix line of the first black matrix line and the second black matrix line having a size that does not cover a pixel pattern.

9. The touch screen apparatus of claim 7, further comprising an interface unit configured to apply a drive signal to a drive line, to receive a sensing signal from a sensing line, and to output the sensing signal to a controller, when the first electrode is the drive line and the second electrode is the sensing line,
wherein the interface unit is further configured to apply the drive signal to a unit of N first electrodes used as the drive line while interlacing a unit of M first electrodes not used as the drive line, and to receive a sensing signal of a unit of X second electrodes used as the sensing line while interlacing a unit of Y second electrodes not used as the sensing line.

10. The touch screen apparatus of claim 9, wherein the interface unit is further configured to simultaneously output the drive signal to one or more drive lines among N drive lines, and to simultaneously process the sensing signal received from one or more sensing lines among X sensing lines.

11. The touch screen apparatus of claim 9, wherein the interface unit is further configured to apply respective drive signals to all of the first electrodes in a precise touch sensing region, and to receive respective signals sensed in all of the second electrodes, when a specific region in a screen is set as the precise touch sensing region.

12. The touch screen apparatus of claim 11, wherein a second electrode in the precise touch sensing region is disposed in the second direction and is connected to the interface unit, and some drive lines, which are used as the drive line in the N first electrodes, are disposed in a region which is not used as the sensing line in the second electrode and which is connected to the interface unit.

13. The touch screen apparatus of claim 7, further comprising an interface unit configured to apply a drive signal to a drive line, and to receive a sensing signal from a sensing line to output to a controller, when the first electrode is the drive line and the second electrode is the sensing line,
wherein, in a normal sensing operation, the interface unit is further configured to apply the drive signal to a unit of N first electrodes used as the drive line while interlacing a unit of M first electrodes not used as the drive line, and to receive a sensing signal of a unit of X second electrodes used as the sensing line while interlacing a unit of Y second electrodes not used as the sensing line, and
wherein, in a precise touch sensing operation, the interface unit is further configured to apply respective drive signals to all of the first electrodes, and to receive respective signals sensed in all of the second electrodes.

14. A touch screen sensor apparatus comprising:
a color filter array including first black matrix lines, which are arranged in a first direction between a plurality of pixels or a plurality of sub-pixels disposed in a display region, and including second black matrix lines, which are arranged in a second direction, the first direction being perpendicular to the second direction; and
a sensor array including first electrodes disposed in a bottom of the color filter array and overlapping a first black matrix line of the first black matrix lines, including second electrodes disposed in a bottom of the color filter array and overlapping a second black matrix line of the second black matrix lines, and including a fingerprint sensing region,
wherein the first electrodes are partially arranged in the fingerprint sensing region of the sensor array and include a first drive line and a second drive line, the first drive line operating as a drive line outside of the fingerprint sensing region, and
wherein the second electrodes include a first sensing line and a second sensing line, the first sensing line operating as a sensing line outside of the fingerprint sensing region.

15. The touch screen sensor device of claim 14, further comprising an interface unit configured to apply a drive signal to the first and second drive lines, to receive a sensing signal from the first and second sensing lines, and to output the sensing signal to a controller,
wherein, in an operation of fingerprint sensing, the interface unit is further configured to apply the drive signal to the first drive line and the second drive line, and to receive a signal sensed from the first sensing line and the second sensing line.

16. The touch screen sensor device of claim 15, wherein, in an operation of finger sensing, the interface unit is further configured to apply the drive signal to the first electrodes of the first drive line, and to receive a signal sensed from the second electrodes of the first sensing line.

17. The touch screen sensor device of claim 16, wherein, in the operation of finger sensing, the interface unit is further configured to simultaneously output the drive signal to one or more drive lines among first drive lines, and to process a signal sensed from one or more sensing lines among first sensing lines.

18. The touch screen sensor device of claim 16, wherein the sensor array is located between a thin film transistor (TFT) glass and the color filter array.

19. The touch screen sensor device of claim 18, wherein the sensor array comprises:
a first insulation layer formed between the first electrodes and the second electrodes; and
a second insulation layer formed between the second electrodes and the TFT glass.

20. The touch screen sensor device of claim 19, wherein the first electrodes and the second electrodes are formed of a metal wire, and have a size that is smaller than a width of the first black matrix lines or the second black matrix lines so as not to cover a pixel pattern.

21. The touch screen sensor device of claim 14, further comprising a display region including a first region and a second region,
wherein the first region of the display region is configured to recognize a fingerprint and to sense a touch of an object, and
wherein the second region of the display region is configured to detect a touch of an object.
